(19) United States
(12) Patent Application Publication
(10) Pub. No.: US 2011/0059837 A1
(43) Pub. Date: Mar. 10, 2011

(54) METHOD FOR PRODUCING SYNTHETIC QUARTZ GLASS

(76) Inventor: Waltraud Werdecker, Hanau am Main (DE)

(21) Appl. No.: 12/736,398

(22) PCT Filed: Mar. 25, 2009
(86) PCT No.: PCT/EP2009/053480

§ 371 Date: Nov. 23, 2010

(30) Foreign Application Priority Data
Apr. 3, 2008 (DE) 10 2008 017 477.7

(51) Int. Cl. C03C 3/04

(52) U.S. Cl. 501/53

(57) ABSTRACT

In a known exterior deposition method for producing synthetic quartz glass, amorphous quartz glass powder particles (13) are fed to a reaction zone (12), the quartz glass powder particles are heated in the reaction zone (12) and deposited on the exterior side of a carrier (10) rotating about an axis of rotation. In order, proceeding from this, to specify a method which is distinguished by a high deposition efficiency, according to the invention it is proposed that amorphous quartz glass powder particles having a particle size of at least 3 μm together with a silicon-containing starting substance (14) are fed to the reaction zone (12), wherein the silicon-containing starting substance (14) is converted to SiO₂ particles in the reaction zone, and the SiO₂ particles are deposited in Co-15 deposition with the quartz glass powder particles on the carrier to form an SiO₂-containing layer (11) in which the quartz glass powder particles (13) make up a proportion by weight of SiO₂ in the range of 30% to 95%.

The present invention relates to a method for producing synthetic quartz glass whereby amorphous quartz-glass powder particles are supplied to a reaction zone, the quartz glass powder particles are heated in the reaction zone and are deposited on a carrier.

### PRIOR ART

For the production of high-purity synthetic quartz glass a multitude of methods are known, wherein SiO₂ particles are produced from a silicon-containing starting substance in a CVD method by hydrolysis and/or oxidation and said particles are deposited on a carrier. A distinction can here be made between outside deposition methods and inside deposition methods. In outside deposition methods, SiO₂ particles are applied to the outside of a rotating carrier. The so-called OVD (outside vapor phase deposition) method, the VAD (vapor phase axial deposition) method or the PECVD (plasma enhanced chemical vapor deposition) method should here be mentioned as examples. The MCVD (modified chemical vapor deposition) method in which SiO₂ particles are deposited on the inner wall of a tube that is heated from the outside is the best known example of an inside deposition method.

In flame hydrolysis, vaporous SiCl₄, for instance, is supplied together with oxygen and hydrogen to a burner flame and is hydrolyzed and oxidized therein with formation of SiO₂ particles. The SiO₂ particles are deposited on a deposition surface with formation of a porous, so-called “soot body” from which in a separate method step the quartz glass component is obtained by vitrification, or the SiO₂ particles are vitrified during deposition on the deposition surface directly into the quartz glass component (this procedure is also called “direct vitrification”).

Both the CVD method using flame hydrolysis and the plasma-enhanced CVD method are faced with the fundamental problem of increasing efficiency with respect to the yield of raw-material and energy input.

To improve the deposition rate in the production of doped quartz glass according to the MCVD method, DE 33 27 484 A1 suggests that the deposition zone produced within a quartz-glass substrate tube should be fed with a reaction gas mixture together with condensation nuclei in the form of quartz glass powder particles having sizes of around 1 μm. The quartz glass powder particles, which are e.g. obtained as “soot dust” in the flame hydrolysis of synthetic SiO₂, are added to a carrier gas or a reaction gas.

The condensation nuclei effect heterogeneous nucleation, thereby increasing the yield of the reaction gas. The heating power needed for the fusion of the condensation nuclei must here be conducted from outside the substrate tube through the substrate tube wall into the reaction zone, which may lead to deformations of the substrate tube.

To improve the deposition rate in an outside deposition method, DE 34 34 598 A1 suggests a method in which pyrogenic silica particles are first produced in the range of 0.01 μm to 0.05 μm by means of a conventional CVD method, these silica particles are received in a dispersion solution and the dispersion solution is subsequently supplied to a burner flame. In the burner flame the silica particles are softened and simultaneously sprayed under pressure of the burner flame onto a carrier with formation of a shaped body of porous SiO₂. At the same time the dispersion solution is evaporated. The shaped body of porous SiO₂ obtained in this way is subsequently vitrified into a quartz glass component.

In a modification of this method according to EP 1 604 957 A1, previously produced pyrogenic silica particles with a maximum diameter of 0.2 μm are fed by means of a carrier gas into a burner flame and deposited on a carrier rotating about its longitudinal axis as a porous SiO₂ shaped body. Pyrogenic silica particles tend to form agglomerates impeding a homogeneous compaction.

Both procedures have in common that a relatively high shrinkage rate is observed during drying and vitrification of the porous shaped body, such shrinkage leading to cracks and flaking. This is also a problem inherent to the soot method.

### TECHNICAL OBJECT

It is the object of the present invention to provide an outside deposition method for producing synthetic quartz glass which is excellent in terms of high deposition efficiency and avoids the above-mentioned drawbacks of the known methods.

Starting from an outside deposition method of the aforementioned type, this object is achieved according to the invention in that the reaction zone is fed with amorphous quartz glass particles having a particle size of at least 3 μm together with a silicon-containing starting substance, the silicon-containing starting substance being converted in the reaction zone to SiO₂ particles, and the SiO₂ particles are deposited in co-deposition with the quartz glass powder particles on the carrier with formation of an SiO₂-containing layer in which the quartz glass powder particles make up a weight proportion of SiO₂ in the range of 30% to 95%.

The reaction zone is e.g. the burner flame of a CVD burner in which the SiO₂ particles are formed by flame hydrolysis or oxidation of the silicon-containing starting substance, or the plasma zone of a plasma burner in which the silicon-containing starting substance is directly converted to SiO₂ particles. In the reaction zone the silicon-containing starting substance is (also) subjected to oxidation all the time with formation of SiO₂ particles.

The quartz glass powder particles previously produced in a separate process are also supplied to the reaction zone and heated therein and thereby softened. The method according to the invention is thus essentially characterized in that quartz glass powder particles previously produced in a separate method step are co-deposited together with the in-situ produced SiO₂ particles of a CVD or plasma deposition process.

“Co-deposition” in this context means that heated and softened quartz glass powder particles are flung and deposited onto a deposition surface together with in-situ produced SiO₂ particles (silica particles) by means of a directed particle stream, both qualities of SiO₂ particles contributing to a significant degree to the deposited quartz glass mass. The SiO₂ particles are here obtained in the form of discrete particles, or they form an agglomerated SiO₂ mass that is particularly also deposited on the quartz glass powder particles.

Since both the originally used quartz glass powder and the SiO₂ particles produced in the reaction zone form a significant part of the quartz glass mass produced in this way, the SiO₂ deposition rate (mass per time unit) is increased in comparison with the conventional procedure, especially when quartz glass powder particles are used having a mass and size exceeding those of the in-situ produced SiO₂ particles many times. Therefore, at least some of the quartz glass powder particles are present with a particle size of 3 μm or more, and the weight proportion of SiO₂, which can be assigned to the quartz glass powder particles, is at least 30%. It has also been found that the “co-deposition” has an advantageous impact on the deposition efficiency (deposited mass in relation to the starting material).

The outside deposition of the quartz glass powder particles is carried out by using a burner flame or a plasma, which permits a rapid heating and softening of the quartz glass powder particles and consequently the introduction of relatively large particles and large particle amounts into the reaction zone and the formation of a particle stream directed towards the deposition surface.

In the event that the “co-deposition” according to the invention yields a porous quartz glass, said glass exhibits a particularly high stability. This is due to the fact that the particularly finely divided SiO₂ particles produced by “co-deposition” act as a “binding phase” for the particles of the quartz glass powder.

It is possible to produce a semifinished product in the form of a ceramic white body which is formed from a porous SiO₂ structure that is composed of the SiO₂ particles produced in situ in the burner flame and of quartz glass powder particles embedded therein. Such a semifinished product shall also be called “white body” hereinafter. The said “binding phase” facilitates the production of mechanically stable “white bodies” of a particularly large volume, which are distinguished by a high white body density and thus by low shrinkage during sintering. Moreover, the “binding phase” effects a reduction of the vitrification temperature, which is also advantageous for the case where a quartz glass is produced by “direct vitrification”, in which the deposited quartz glass powder particles and SiO₂ particles are directly vitrified on the deposition surface. These effects of the “binding phase” are noticed when the weight proportion of SiO₂, which is due to the SiO₂ particles, is at least 5%.

The quartz glass produced according to the method of the present invention forms a vitrified layer on a substrate or a vitrified blank of transparent, translucent or opaque quartz glass, or it forms a semifinished product in the form of a porous white-body layer on a substrate or in the form of a porous white body that in a subsequent vitrification process is further processed into the transparent, translucent or opaque quartz glass.

The quartz glass is suited for applications that are also otherwise standard, particularly for the production of components for use in semiconductor production, such as flanges of opaque quartz glass or wafer holders of transparent quartz glass. When pyrogenic silica of high purity is used, the method is also suited for the production of synthetic sophisticated quartz glass bodies for optics and communication engineering. An opaque component produced according to the method and a layer formed therefrom also exhibit good reflector properties over a wide wavelength range, particularly also in the ultraviolet wavelength range, and predestine the quartz glass for applications as a diffusing reflector, for instance also in reactor chambers and furnaces in semiconductor production.

Advantageously, the quartz glass powder particles have different grain sizes. Preferably, quartz glass powder particles with a mean particle size of from 0.2 μm to 30 μm are used, particularly preferably with a mean particle size in the range of from 3 μm to 15 μm.

Thanks to the use of relatively large quartz-glass powder particles the efficiency of the deposition process can be improved and the susceptibility to cracks of the porous quartz glass can be reduced at the same time on condition that the large quartz glass powder particles, coincide in a “co-deposition” process with a “binding phase” of in-situ produced SiO₂. As a result, a comparatively low shrinkage is achieved during dehydration and vitrification of the porous quartz glass. The use of particularly large quartz-glass powder particles is particularly to be considered for the production of opaque quartz glass according to the outside deposition method according to the invention.

The quartz glass powder particles can be supplied to the reaction zone by means of a conveying gas via a separate powder conveying means or another fluidizing means. One procedure, however, has turned out to be particularly advantageous wherein the quartz glass powder particles are supplied to the reaction zone via a supply nozzle of a burner. The burner is e.g. a deposition burner for flame hydrolysis or a plasma burner. The quartz glass powder particles are here supplied via a powder nozzle of the burner, which nozzle is centrally or concentrically arranged as a rule, directly into the reaction zone, i.e., e.g. a burner flame or into an arc. The supply of the powder into the reaction zone that is thereby accomplished has the advantage that the powder is not blown away to the outside or is less blown away to the outside due to the flame or arc pressure.

In this context it has also turned out to be particularly advantageous when the quartz glass powder particles are fed to the reaction zone in a carrier gas stream together with the silicon-containing starting substance.

It is already before the entry into the reaction zone that there is an intimate mixing between the quartz glass powder particles and the silicon-containing starting substance, which is conducive to the homogenous impact of the silicon-containing starting substance and the in-situ produced SiO₂ particles on the quartz glass powder particles, thereby enabling the deposition of a particularly stable white body of porous quartz glass.

It has also turned out to be advantageous when the quartz glass powder particles have a spherical shape.

In comparison with a rather splintery, edged particle shape, a spherical shape promotes improved fluidization and the setting of a higher solid density in the deposition layer, resulting in a lower shrinkage at the same time and enhanced insensitivity to cracking and mechanical stability of the white body of porous quartz glass. As for a fusion process without any bubbles, if possible, the quartz glass powder particles preferably exhibit no inner porosity.

Furthermore, it turns out to be advantageous when the quartz glass powder particles are supplied to the reaction zone in an amount which in the SiO₂-containing layer makes up a weight proportion of SiO₂ in the range between 40% and 80%.

With a weight proportion of the quartz glass powder particles of less than 40%, their advantageous effect in terms of increased deposition efficiency is less noticed, whereas in a weight proportion of the SiO₂ particles of less than 20% their advantageous effect with respect to an increase in the sintering activity is relatively small, which requires a comparatively high sintering temperature or a high vitrification temperature (during direct vitrification).

As for the use of the quartz glass for optical applications, a procedure has turned out to be useful in which quartz glass powder particles are employed that have previously been subjected to a cleaning treatment in a chlorine-containing atmosphere.

Owing to the cleaning treatment in a chlorine-containing atmosphere, above all metallic impurities are removed. Moreover, the content of hydroxyl groups in the quartz glass can be reduced.

During the layerwise deposition of the SiO₂ layer the process parameters, such as ambient atmosphere or temperature, can be changed, just like the composition of the materials used, also particularly the properties and quality of the quartz glass powder particles or possible additives. SiO₂ layers can thereby be produced having properties that are changing gradually or in steps across the layer thickness. Therefore, the method according to the invention is particularly also suited for the production of quartz-glass components with an inhomogeneous, particularly graduated, distribution of properties, such as chemical or thermal resistance or optical properties.

In this respect it has turned out to be advantageous when an additive that releases a gas at a high temperature is supplied to the reaction zone together with the quartz glass powder particles.

The at least one additive is present as a separate powder or as a dopant of the quartz glass powder particles, and it is homogeneously or inhomogeneously distributed in the finished layer. At the vitrification temperature or already at a lower temperature the additive releases a gas, e.g. due to decomposition or a chemical reaction with the ambient atmosphere. As a result, a predetermined degree of porosity of the quartz glass can be produced in a reproducible way. A suitable additive is Si₃N₄ which during heating releases gaseous components, such as nitrogen, by way of thermal decomposition. The gaseous components form pores in the softened quartz glass, thereby producing the desired opacity of the SiO₂ layer or of an outer layer region in which the additive is contained.

In a further, particularly preferred variant of the method, it is provided that the co-deposition process comprises a first deposition phase and at least one second deposition phase, the reaction zone being fed in the first deposition phase with quartz glass powder particles of a different composition or in an amount differing from that in the second deposition phase.

This method variant enables a stepwise or continuous change in properties across the thickness of the SiO₂-containing layer. The changes in the properties are effected by changing the respective amount in the whole SiO₂ of the layer region concerned or by changing the constitution thereof or by adding one or several additives.

Especially for applications in which a particularly high purity is required, e.g. in a near-core region of an optical preform, a procedure has turned out to be useful in which in the first deposition phase the reaction zone is not fed with quartz glass powder particles or is fed with quartz glass powder particles in a smaller amount and/or with a lower impurity or hydroxyl-group content for forming an inner region of the SiO₂ layer than in the second deposition phase for forming an outer region of the SiO₂ layer.

For instance, an inner—near-core—layer region of a preform, in the case of which a particularly low hydroxyl group content is required, can be produced either entirely or predominantly by using the high-purity silicon-containing starting material, whereas layer regions in which the hydroxyl group content is allowed to be higher, e.g. in the outer jacket region of a preform, can be produced by way of co-deposition together with quartz glass powder particles with a slightly higher hydroxyl group content, but in return with a particularly high deposition efficiency.

In a particularly preferred embodiment of the method, it is intended that the quartz glass powder particles are degassed in vacuum by heating to a temperature in the range of between 900° C. and 1200° C., so that a hydroxyl group content of less than 1 wt. ppm is obtained.

Degassing of the quartz glass powder particles takes place before the application for forming the SiO₂-containing layer or thereafter. Drying before the application diminishes the tendency to form agglomerations and facilitates the fluidization of the powder. It has been found that heating to a comparatively low temperature below 1200° C. in vacuum (<2 mbar) is enough for achieving a lower hydroxyl group content in the quartz glass of the quartz glass powder particles. This is due to short diffusion paths. The addition of a halogen-containing gas, as is standard in the prior art, is thus not needed for drying and does also not show any significant drying effect in the vitreous quartz-glass powder particles.

It is intended in a particularly preferred method variant that the quartz glass powder particles are used with a multimodal particle size distribution that shows at least one size distribution maximum in the range of 0.2 μm and 2 μm and at least one size distribution maximum in the range of 3 μm to 30 μm.

The quartz-glass powder particles are present in a particle size distribution that has two or more maxima. At least one of the maxima, namely a secondary maximum, is within the finely divided range with particle diameters below 2 μm; a further maximum, namely the main maximum, is in the coarse-grain range with particle diameters above 3 μm. Such a multimodal particle size distribution with at least two grain distributions that differ from one another in their mean size reduces the energy input needed for dense sintering or during direct vitrification.

The carrier is preferably present in the form of a core rod that comprises a core glass and a cladding glass surrounding the core glass. The core rod is a semifinished product of quartz glass for the production of a preform for optical fibers. Owing to the application of a further cladding material in the form of the SiO₂ layer a preform can be obtained directly, and an optical fiber is drawn from said preform.

In-situ produced SiO₂ soot particles that do not deposit on the carrier or another deposition surface can advantageously be intercepted and returned to the process. This cycling process provides for improved material yield, and it has been found that the diameters of the recycled SiO₂ particles are successively increasing. Such recycled SiO₂ particles can enhance the sintering activity, with the weight proportion of the total SiO₂ mass being however less than 10%.

### EMBODIMENT

The present invention shall now be explained in more detail with reference to embodiments and a drawing, in which:

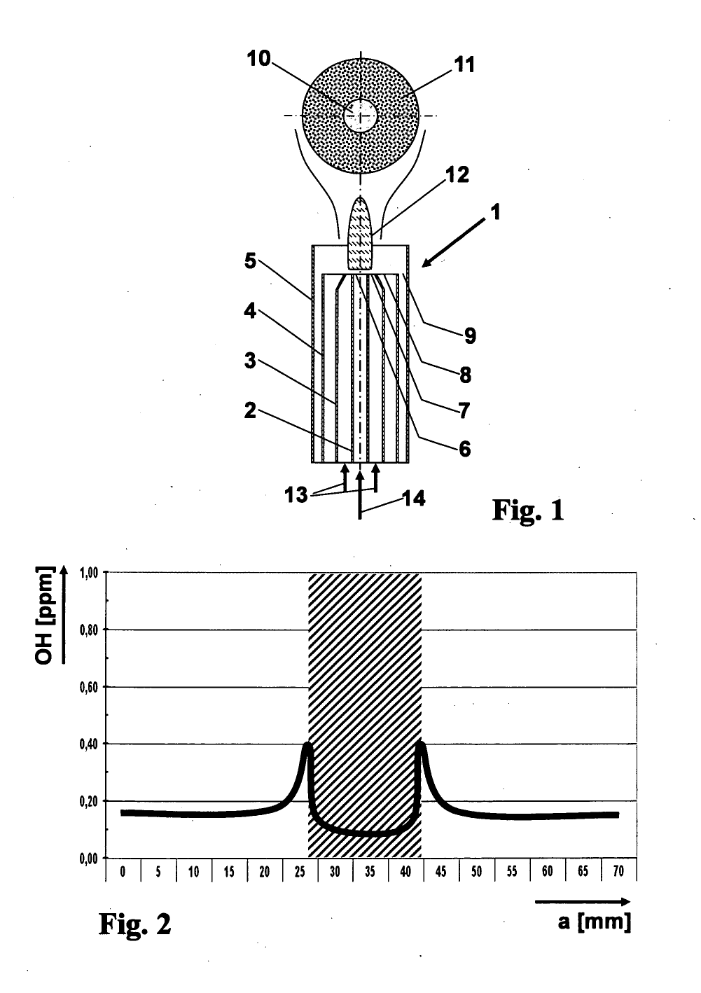

FIG. 1 shows the production of a SiO₂ blank using a deposition burner, in a schematic view;

FIG. 2 shows a typical progress of the hydroxyl group content over the radial cross-section of a preform produced according to the method of the invention.

### EXAMPLE 1

FIG. 1 shows a standard deposition burner 1 for producing a porous SiO₂ blank according to the OVD method. It consists of a total of four quartz glass tubes 2, 3, 4, 5 that are coaxially arranged relative to one another and form a central nozzle 6, a separation gas nozzle 7, an annular gas nozzle 8 and an outer nozzle 9.

The modification according to the invention regarding a conventional OVD method using the deposition burner 1 shown in FIG. 1 shall be explained hereinafter:

A commercial powder of amorphous quartz glass powder particles with spherical shape that is distinguished by a multimodal particle size distribution with a relatively narrow maximum of the size distribution at about 5 μm (D₅₀ value) and with a secondary maximum in the range of around 0.5 μm, is previously cleaned in a hot chlorination method at a temperature of 900° C.

The central nozzle 6 of the deposition burner 1 is fed with vaporous SiCl₄ at a rate of 4 l/min and oxygen. The supply of SiCl₄ is symbolized by the directional arrow 14. Separation gas oxygen is passed through the separation gas nozzle 7, with the oxygen/separation gas stream simultaneously serving as the carrier gas for the afore-described amorphous quartz glass power particles. The flow velocity thereof is 35 m/s. The supply of the quartz glass powder particles is symbolized by the directional arrows 13.

Hydrogen is passed through the annular gap nozzle 8 and fuel gas/oxygen through the outer nozzle 9, the said gas streams (SiCl₄+carrier gas/hydrogen, separation gas/oxygen, hydrogen, fuel gas/oxygen) being in this order in a quantitative ratio of 1:1:10:3 with one another.

For producing an optical preform a core rod 10 is provided that comprises a core of doped quartz glass and an inner jacket cladding the core and consisting of undoped quartz glass. The core rod 10 has an outer diameter of 43.8 mm and a b/a ratio (=outer diameter divided by the diameter of the doped core region) of 3.51. It is drawn off to a diameter of 15.2 mm. Subsequently, the doped core has a diameter of 5 mm.

In-situ produced SiO₂ soot particles are deposited on the core rod 10 rotating about its longitudinal axis by means of the deposition burner 1 by flame hydrolysis of SiCl₄, in co-deposition with quartz glass powder particles 13 in a particle stream directed onto the cylindrical outer surface. The particle size of the in-situ produced SIO₂ soot particles lies typically around 40 nm at a relatively wide particle size distribution. Due to a reversing movement of the deposition burner 1 along the longitudinal axis of the carrier, one obtains a layer-like SiO₂ blank 11 of porous quartz glass with a build-up density of about 1.4 g/cm.

After the layered SiO₂ blank 11 has reached an outer diameter of 105 mm, the deposition process is stopped. The composite body produced in this way and consisting of core rod 10 and porous SiO₂ layer (blank 11) is dehydrated in that it is heated in a vacuum furnace at a heating rate of 1° C./min to a temperature of 950° C. and is held at this temperature for 6 hours. During the heating phase and during the holding period the helium atmosphere of the furnace is replaced several times. This results in an alternating treatment in vacuum (pressure=0.01 mbar) and in a He atmosphere with a helium partial pressure of 1000 mbar. The temperature treatment in vacuum in alternation with gas purging processes in helium makes the temperature homogeneous within the white body, so that, also promoted by the relatively high heat conductivity of helium, a uniform and homogeneous dehydration of the SiO₂ grain layer is obtained. Following this pretreatment (after a treatment duration of 22 hours) a hydroxyl group content of less than 0.2 wt. ppm is obtained in the SiO₂ layer 11.

This layer 11 is distinguished by a high mechanical stability and the absence of cracks. The composite body produced in this way is subsequently heated in vacuum (0.01 mbar) to a temperature of 1500° C. and held at this temperature for about 5 hours before it is cooled in helium atmosphere. For eliminating geometric irregularities, the resulting transparent preform is ground prior to fiber drawing from an outer diameter of 75 mm to 70 mm and subsequently cleaned with HF acid.

FIG. 2 is a schematic illustration showing a typical curve of the hydroxyl group content across the radial cross-section of a preform obtained according to the above method. The measured hydroxyl group content is plotted in wt. ppm on the y-axis and the distance in mm on the x-axis, starting from the first measuring point. The area of the core rod is marked by way of the hatched surface area.

The hydroxyl group content in the area of the outer jacket, which has been obtained with the method according to the invention, is below 0.2 wt. ppm. In the area of the boundary with the inner jacket of the core rod, the hydroxyl group content is increasing to a still acceptable Value of about 0.4 wt. ppm. A locally exact measurement showed that the increase has to be assigned to the core rod surface and is probably due to the elongation process of the original core rod. The OH content is about 0.1 wt. ppm in the interior of the core rod.

### EXAMPLE 2

A modification of the method explained with reference to Example 1 differs in the following measures: Instead of the core rod, a carrier is used in the form of a carrier tube of quartz glass, oxygen is exclusively supplied to the separation gas nozzle 7 of the deposition burner 1, with the help of a separate fluidizing means (not shown in the figure) a fluidized powder mixture is sprayed into the burner flame 12 by means of an oxygen/carrier gas stream. The fluidizing means consists of a closed container from which the powder mixture is introduced by means of a turbulent gas stream via a supply nozzle at an acute angle into the burner flame. The powder mixture is composed at 95% by wt. of the above-described and previously cleaned amorphous quartz glass powder particles and at 5% by wt. of pyrogenic silica particles; these are non-deposited SiO₂ soot particles issuing from the deposition chamber that are circulated to the fluidizing means.

The supply rate of the powder mixture corresponds to that of Example 1. The sum of the flow rates of the oxygen/separation gas stream and of the oxygen/fluidization and carrier gas stream corresponds to that of the oxygen/separation gas stream of Example 1. The weight ratio, based on the total mass of SiO₂, of in-situ produced SiO₂ on the one hand and of quartz glass powder particles and silica particles on the other hand is about 1:5. A particle stream directed to the cylindrical outer surface of the carrier is thereby produced and a porous SiO₂ soot layer is deposited thereon.

The white body consisting of porous quartz glass, which has been produced by co-deposition of the SiO₂ soot particles, quartz glass powder particles and silica particles, is dried on the carrier tube, as has been explained above with reference to Example 1. The white body is distinguished by a high white-body density of somewhat more than 1.4 g/m³ and a low tendency to cracking and a high mechanical stability. After the carrier tube has been removed, it is introduced into a sintering furnace and sintered there in an air atmosphere at a temperature of 1400° C. for a holding period of 3 h.

This results in an opaque, inherently closed-pore tubular body having a density of 2.18 g/cm³. The surface is sealed with a transparent layer having a thickness of about 1 mm. Rings are cut from the tubular body, the rings being further processed into large flanges for quartz-glass reactor chambers for use in semiconductor manufacture.

The semifinished product produced in this way is distinguished by a particularly high reflectivity and low absorption over a wide wavelength range and is therefore particularly suited for use in hot processes.

### EXAMPLE 3

In a modification of the method explained above with reference to Example 2, the white body is introduced into a sintering furnace after removal of the carrier tube and sintered therein in vacuum (pressure=0.01 mbar) at a temperature of 1500° C. for a holding period of 5 h to obtain a hollow cylinder of transparent quartz glass having a hydroxyl group content of 0.112 wt. ppm and in the case of which the total content of the impurities Li, Na, K, Mg, Fe, Cu, Cr, Nb, Ti, Zr and Ni is below 160 wt. ppb.

Rings are cut out from the hollow cylinder and these are further processed into wafer holders of transparent quartz glass for use in semiconductor manufacture.

1. An outside deposition method for producing synthetic quartz glass, said method comprising:
supplying amorphous quartz-glass powder particles to a reaction zone;
heating the quartz glass powder particles in the reaction zone;
depositing said quartz glass powder particles on an outside of a carrier rotating about an axis of rotation; and
wherein said amorphous quartz-glass powder particles have a particle size of at least 3 μm and are supplied to the reaction zone together with a silicon-containing starting substance, the silicon-containing starting substance being converted in the reaction zone to SiO₂ particles, and the SiO₂ particles are deposited in co-deposition with the quartz glass powder particles on the carrier so as to form a SiO₂-containing layer in which the quartz glass powder particles make up a weight proportion of SiO₂ in a range of 30% to 95%.

2. The outside deposition method according to claim 1, wherein the quartz glass powder particles have a mean particle size in a range of 0.2 μm to 30 μm.

3. The outside deposition method according to claim 1, wherein the quartz glass powder particles are supplied to the reaction zone via a supply nozzle of a burner.

4. The outside deposition method according to claim 3, wherein the quartz glass powder particles are supplied to the reaction zone in a carrier gas stream together with the silicon-containing starting substance.

5. The outside deposition method according to claim 1, wherein the quartz glass powder particles are spherical in shape.

6. The outside deposition method according to claim 1, wherein the quartz glass powder particles are supplied to the reaction zone in an amount that makes up a weight proportion of SiO₂ in a range between 40% and 80% in the SiO₂-containing layer.

7. The outside deposition method according to claim 1, wherein the quartz glass powder particles have previously been subjected to a cleaning treatment in a chlorine-containing atmosphere.

8. The outside deposition method according to claim 1, wherein an additive that at a high temperature releases a gas is supplied to the reaction zone together with the quartz glass powder particles.

9. The outside deposition method according to claim 1, wherein the co-deposition process comprises a first deposition phase and at least one second deposition phase, the reaction zone being supplied in the first deposition phase with said quartz glass powder particles of a composition or in an amount differing from a composition or amount thereof in the second deposition phase.

10. The outside deposition method according to claim 9, wherein in the first deposition phase, the reaction zone is not supplied with the quartz glass powder particles, or is supplied with said quartz glass powder particles in a smaller amount and/or with a lower impurity or hydroxyl-group content in forming an inner region of the SiO₂ layer than the amount and/or impurity in the second deposition phase in forming an outer region of the SiO₂ layer.

11. The outside deposition method according to claim 1, wherein the quartz glass powder particles have a multimodal particle size distribution with at least one size distribution maximum in a range of 0.2 μm and 2 μm and at least one size distribution maximum in a range of 3 μm to 30 μm.

12. The outside deposition method according to claim 1, wherein the quartz glass powder particles are degassed in vacuum by heating to a temperature in a range between 950° C. and 1200° C., so that a hydroxyl group content of less than 1 wt. ppm is obtained.

13. The outside deposition method according to claim 1, wherein a core rod that comprises a core glass and a cladding glass that surrounds the core glass is used as the carrier.

14. The outside deposition method according to claim 1, wherein the quartz glass powder particles have a mean particle size in a range of 3 μm to 15 μm.
